(19) United States
(12) Patent Application Publication
(10) Pub. No.: US 2005/0161874 A1
(43) Pub. Date: Jul. 28, 2005

(54) Clamp stand

(76) Inventor: Ted Michael Torgrimson, Faribault, MN (US)

Correspondence Address: Ted Torgrimson, 903 6TH AVE. S.W., ROCHESTER, MN, 55902, US

(21) Appl. No.: 10/662,201

(22) Filed: Jan. 26, 2004

(51) Int. Cl. B23Q 3/02

(52) U.S. Cl. 269/96

(57) ABSTRACT

The Clamp Stand is a tool made of aluminum matel in a square form. These three sizes fit the most commonly used sizes of the market of hardware Clamps. These common sizes are ½ inch, ¾ inch and 1 inch in diameter. The reasoning for this tool is to increase a very commonly used tools ability to preform objectives. The Clamp Stand helps hold things in place that the Clamp alone could not correctly do. It is a very practical tool thats easy for most individuals to understand and put to use.

### FIELD OF INVENTION

The Clamp Stand was originally put together in a wood shop I work in. It seems very useful in the types of work I do. I believe any wood shop would benefit from this extra tool.

### BRIEF SUMMARY

This tool is a easy tool to use. It helps holding things in place for work. Many times it seems difficult to hold a long or large object while trying to mount it or connect it to its place of purpose.

### BRIEF DESCRIPTION OF DRAWINGS

In FIG. 1 is a view looking straight down at the large Clamp Stand.

FIG. 2 is a view looking straight down at the medium size Clamp Stand

FIG. 3 is a view at the commonly used Clamp.

FIG. 4 is a view looking straight down at the small Clamp Stand.

FIG. 5 is a side view of all sizes of the Clamp Stand.

FIG. 6 is a view of the Clamp Stand ready for use.

### DESCRIPTION OF THE PREFERRED EMBODIMENT

The Clamp Stand is made as addition to a widely used tool throughout the world by all wood shops, the Clamp. Using the Clamp Stand is very easy and improves what a single person can accomplish. Its specifically made to hold materials in a easier place for installment.

The Clamp Stand is very basic for making in any shop with access to a drill press, metal drilling bits, kit for threading and a band saw.

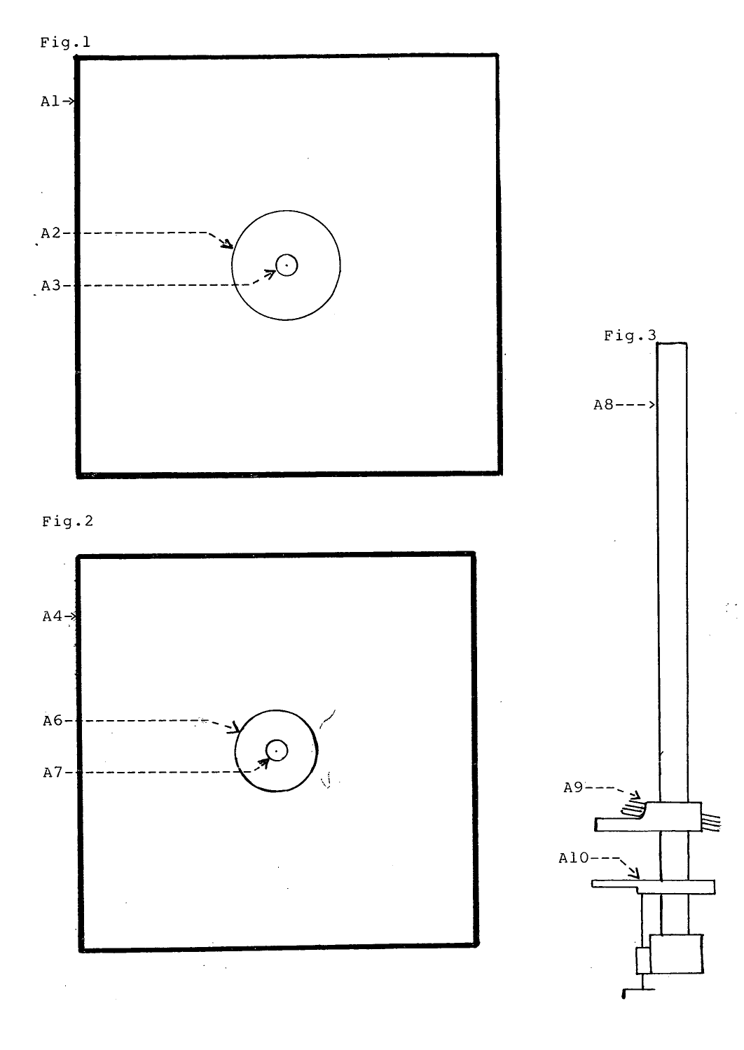

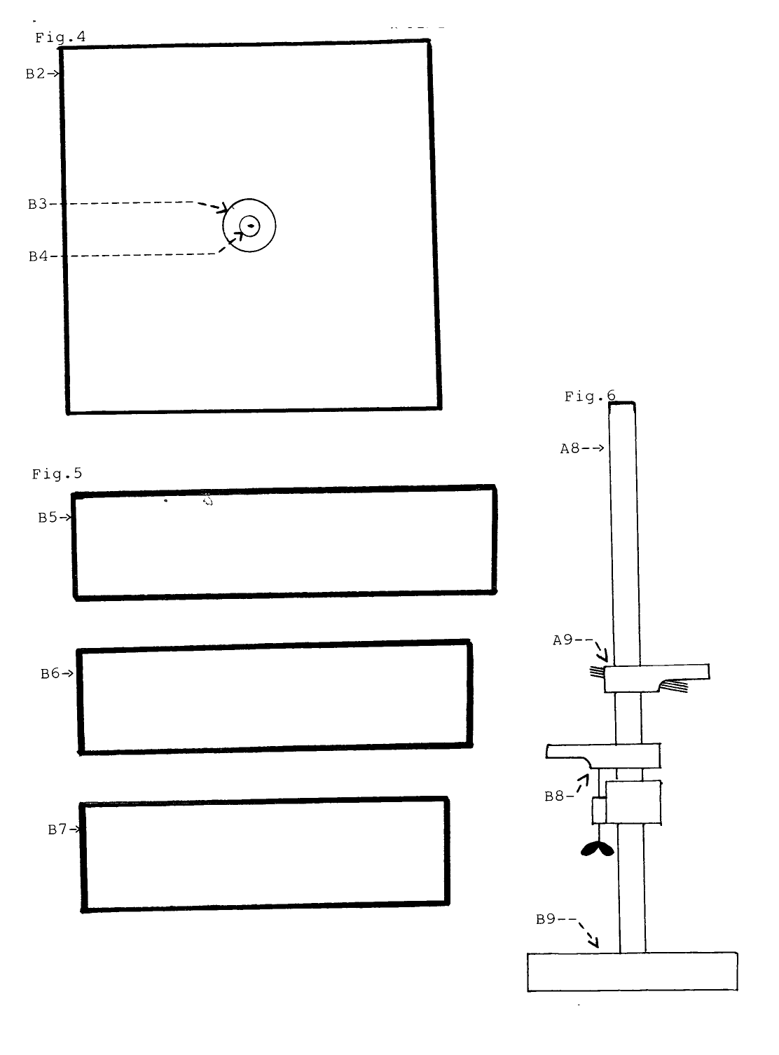

To begin this process blocks of aluminum at wanted width in inches at what ever length available must be cut on the band saw to a size for use. FIGS. #1, #2, and #4 show the three sizes to be made. FIG. #1 is 4 by 4 by 1 in inches. FIG. 2 is 3¾ by 3¾ by 1 in inches and #4 is 3½ by 3½ by 1 in inches. FIG. 5 shows side views of this after cuts have been completed.

Next you must mark the center of the top and drill a hole directly threw with the drill press and a 1/4 inch bit. This 1/4 inch can be used in all three sizes. This is shown in FIGS. 1, 2 and 4 marked as A3, A7 and B4. Now your bit size must be changed to fit pole size. The large size must have a 1 inch hole placed to a depth of ¾ of an inch. The medium size must have a 3/4 inch hole placed at a depth of ¾ of an inch. The small size must have a 1/2 inch hole place at a depth of ¾ of an inch. This is shown in FIGS. 1, 2 and 4 marked as A2, A6 and B3.

You must now take your die and tap kit for threading and thread each size with pipe threading. This now makes the Clamp Stand complete for use. FIG. 3 is the Clamp you will use for the Clamp Stand. B1 is removed so the threading can be placed in the Clamp Stand. Now A8 shown in FIGS. 3 and 6 is standing. FIG. 6 is it at use. The slide bar marked as A9 must be turned over and can then be used, B8 is another type of slide bar. B9 shown in FIG. 6 is the Clamp Stand in use. This can now be used to hold many things in place like drawer slides in cabinets.

1. What I, Ted M Torgrimson claim as my invention is named lamp stand, made for adding ability to a very commonly tool.
